(19) United States
(12) Patent Application Publication
(10) Pub. No.: US 2017/0134411 A1
(43) Pub. Date: May 11, 2017

(54) Methods and Automated Systems to Effectively Resist (PAMD) Cyber Attacks

(71) Applicant: Gewei Ye, Timonium, MD (US)

(72) Inventor: Gewei Ye, Timonium, MD (US)

(21) Appl. No.: 14/935,556

(22) Filed: Nov. 9, 2015

(51) Int. Cl. H04L 29/06

(52) U.S. Cl. CPC H04L 63/1425; H04L 63/1491

(57) ABSTRACT

This patent includes three claims of inventions for the methods and automated systems to effectively resist (predict|attenuate|measure|detect—P.A.M.D.) cyber attacks. Claim 1 comprises of the automated modeling and computing (AMP) method and the AMP cloud system to enable the PAMD-P capability that produces predictive intelligence and may enable a paradigm shift from past to future-oriented enterprise and national-security cyber defense. Claim 2 comprises of the method and system that enables PAMD-A capability that effectively attenuates and resists cyber attacks by the method of sensor deceptions. Claim 3 comprises of the methods and systems to enable PAMD-M and PAMD-D capabilities that automatically measure the performance of network defense and automatically run a number of analytics on a variety of datasets of large volumes.

### BACKGROUND

1.1 Field of the Invention

Due to ineffective cyber defense of enterprise and government networks, cyber security challenges become top priorities for many enterprises and the national security agenda. For these increasing cyber security challenges, the consequences are significant due to cyber incidents. For example, Target CEO and CTO lost their jobs (http://www.entrepreneur.com/article/233911); JPMorgan lost $900 million (http://www.pymnts.com/news/2015/how-100-banks-got-hacked-and-lost-900-million/); and the OPM of U.S. federal government lost the sensitive data of 21 million employees and contractors (http://thehill.com/policy/cybersecurity/247968-opm-hack-notifications-could-take-weeks).

How to effectively resist cyber attacks which cause such severe consequences? Based on more than ten years of scientific research, we developed methods and automated systems to effectively resist cyber attacks. These methods and systems can resist cyber attacks with four major capabilities: predicting|attenuating|measuring|detecting, i.e., the P.A.M.D. capabilities. The methods that enable the P.A.M.D. capabilities are called P.A.M.D. methods. The systems that automate the P.A.M.D. methods to enable the capabilities are called the P.A.M.D. systems. PAMD is P.A.M.D. in short.

1.2 Description of the Related Art

FIG. 1 illustrates the four capabilities enabled by four PAMD methods and four cloud systems, i.e., the AMP (Automated Modeling and Prediction) method and cloud, the UCI (U.S. CyberRisk Index) method and cloud, the SPC (Sensor Portal Cloud) method and cloud, and the RAD (Rapid Analytics Detection) method and cloud. More details on the PAMD capabilities may be found at http://deepcybe.com.

P.A.M.D. software sensors can be installed on three types of hardware sensors to enable the P.A.M.D. capabilities: the cloud, the physical, and the small IoT (Internet of Things) hardware sensors. All of these sensors collect cyber data to enable PAMD capabilities for network defense. One of the PAMD capabilities, PAMD-A, may deploy the sensors next to the defended asset as fake targets to deceive and mislead cyber attacks. As a result, the attacks to the asset may be attenuated to insignificance.

P.A.M.D. sensors may be employed as the method of cyber deceptions to alter cyber attackers' perception of reality (i.e., hide the real asset among sensor deceptions). So we hypothesize that the sensor deceptions may “alter the underlying attack process, making it more difficult, time consuming and cost prohibitive, working with other cyber defense methods” (except from a DoD RFP).

The PAMD-P capability is a unique capability of automated artificial intelligence modeling and prediction to produce predictive intelligence for national security. In the common scale of analytics maturity (see FIG. 2), PAMD-P, the capability to develop automated predictive models that can be optimized to deliver the best future outcome, sits at the most advanced stage of analytics. The AMP method and the PAMD-P capability are automated by the AMP cloud so it will take a short time to get the expected results from complicated cyber-attack datasets. To summarize, the AMP method, the AMP cloud system, and the PAMD-P capability pioneer the field of automated advanced analytics in cyber-security research and practice.

1.2.1 PAMD-P: Predicting Cyber Attacks with AMP

PAMD-P is a next-gen cyber security analytics capability powered by deep learning algorithms and automated predictions. Our breakthrough and invention of automated modeling and prediction (v.s. traditional modeling) power the first artificial intelligence solution to enable a paradigm shift from past to future-oriented cyber defense for national and enterprise security.

FIG. 3 shows the expected result of implementing the PAMD-Predict (automated) capability to produce predictive intelligence (chart) for national security (e.g., DISA, DoD, NSA) data feeds. The expected result can be produced from the AMP cloud system that automates the AMP method and algorithms.

FIG. 3 is also designed to enable practical interoperability interfaces by the loose-coupling principle. So many forms of external cyber-attack datasets (e.g., datasets that are not from the SPC cloud or the PAMD-A sensors) can be automatically processed by the AMP cloud for predictive intelligence.

1.2.2 PAMD-A: Attenuating Cyber Attacks with Sensor Deceptions and MFA

The PAMD systems may engage cloud and IoT cyber sensor deceptions to effectively attenuate cyber attacks. The PAMD systems pioneer in the cyber defense industry to capture and attenuate cyber attacks by deploying cloud and IoT cyber sensors as the method of sensor deceptions. FIG. 4 shows a real attack scenario in which the PAMD-A sensors capture and summarize the statistics of attackers to a U.S. network.

In addition to capturing and collecting attackers' data, the PAMD-A sensors can operate cyber deceptions to attenuate cyber attacks. FIG. 5 illustrates the key enabling concepts and the work flow to achieve the two objectives: deploy an effective network defense for sensor deceptions; and optimize the network defense to the condition that produces the best cyber deception effect to attenuate cyber attacks.

The PAMD-A system with the following methods designs and optimizes the cyber deception effect for next-gen network defense:
1. Develop a network environment (e.g., a cyber range) following PAMD systems' technical architecture (see FIG. 8), e.g., one or several virtual private cloud (VPCs) with cloud instances as the asset to be defended (see Listing 2). If needed, enable the multi-factor authentication (MFA) switch (on/off) for the network.
2. Deploy one or many PAMD-A cyber sensors (powered by honeypots) as fake targets for perimeter defense (before firewalls) or the host defense, i.e., next to the asset to form a load-balanced (with the on/off setting) cluster in the VPC.
3. Simulate cyber-attack use cases (INFOCON 1-5) to the VPC network with DC's Penetration Test Platform or open an experimental cyber range to attract real cyber-attacks.
4. Collect the cyber-attack benchmark metric (i.e., without a sensor) and compute the cyber deception effect (CDE) metrics (i.e., with one or many sensors) for the VPC(s). Adapt the UCI (U.S. CyberRisk Index) algorithm to compute the effect of the cyber deception by the PAMD-A sensors. UCI, created for the PAMD-M capability, is a percentile metric to measure cyber risks and the performance of network defense.
5. Compare the VPC deception effect metrics for different conditions of deployment methods (e.g., security groups, firewalls, load balancer switch, MFA switch, protocols, ports etc.) and number of fake targets (i.e., sensor deceptions).
6. Recommend the optimal condition for the best cyber deception effect. We shall support the Deception Hypothesis with empirical data that the sensor deceptions may effectively alter the attack process, thus attenuate the strength of the attack impact to insignificance.
7. Demonstrate the key enabling concepts (e.g., PAMD-A capability, cyber sensors as deceptions, asset to defend, VPC network, and CDE metrics for network defense) in the cyber environment.

1.2.3 PAMD-M: Monitoring Live Cyber Attacks to Support National Security

On July 8, the PAMD demo systems deployed on an open U.S. network discovered a high spike of cyber activities through the U.S. cloud sensors and the live UCI chart (see FIG. 6). This was related to three events happened on the same day: computer systems of NYSE's trading (e.g., financial market stopped), United Airlines (e.g., air planes could not fly), and Wall Street Journal were all crashed. Though all three companies claimed computer glitches were the root causes, the cyber-security scoring and monitoring system, the UCI cloud of the PAMD-M capability suggested otherwise: possible cyber-attacks.

The UCI metric automatically measures cyber health and the performance of U.S. network defense based on aggregated cyber-attack datasets from the PAMD-A sensors. The UCI is an automated percentile metric: the percentage of total days scored under today's UCI score. A higher UCI score means a higher CyberRisk level.

In addition to automatically and regularly scoring cyber security performance of network defense, the PAMD-M method and system is capable of tracing the IP addresses, names, physical addresses, countries, phones, and other actionable information and insights about the cyber attackers. With this priceless information, FBI and law enforcement may contact the potential cyber attackers to effectively prevent future attacks.

1.2.4 PAMD-D: Detect Signals (e.g., Patterns, Anomalies, and Insights)

FIG. 7 shows the PAMD-D capability by the method of a conjoint analysis on the dataset captured by the PAMD-A sensors and the Sensor Portal Cloud (SPC) system. The PAMD-D capability is enabled by the Rapid Analytics Detection (RAD) cloud system that automatically detects signals (e.g., patterns, anomalies and insight) from structured and unstructured data.

With the RAD cloud of automated advanced analytics and its user-friendly Web interface, generals and captains of a cyber defense operations center can click a few buttons of the RAD system to gain deep insights from cyber-attack datasets of large volumes. For example, the conjoint analytics of the RAD cloud can produce actionable insights by the charts shown on FIG. 7 with a few clicks. Using the charts, generals and captains can make right decisions or predictions based on the actionable insights.

1.2.5 PAMD Architecture and Interoperability

How do the four PAMD cloud systems work together functionally? FIG. 8 shows the connections between the four PAMD cloud systems.

PAMD-A sensors collect cyber-attackers' datasets and the SPC cloud 1 aggregates the sensor data in a MongoDB database with a Web-Portal user interface. The aggregated sensor datasets may be automatically transformed to the UCI metric cloud 2 to measure the performance of network defense (i.e., the cyber-security score card) on a regular basis (e.g., daily, hourly, or monthly). The UCI metric datasets may then be automatically sent to the AMP cloud 3 for predictive intelligence. The predictive intelligence charts may be accessible on Web or in email. Many types of datasets such as the UCI dataset, the original sensors' datasets, or other external datasets may be sent to RAD cloud 4 directly or indirectly for signal detection and automated advanced analytics such as conjoint analytics.

How do the PAMD enterprise systems communicate to each other effectively and seamlessly? The API/SOA architecture has been designed to enable the successful automated communications between the PAMD cloud systems that are built with different computing languages and platforms. For example, datasets from the SPC cloud 1 are automatically transported to the UCI cloud 2 and/or the RAD cloud 4 by an API call with a RESTful endpoint. Datasets from the UCI cloud 2 are automatically transported to the AMP cloud 3 by another API endpoint.

As a result, the design principle of loose coupling for modern system integration is materialized for the PAMD cloud systems that do not become a tightly-coupled single stack system. In other words, the PAMD systems are open to take in many types of datasets for many numbers of analytics. For example, the RAD cloud 4 and the AMP cloud 3 may take in the PAMD datasets and many other kinds of external datasets (e.g., not from the PAMD-A sensors) for automated advanced analytics and automated and optimized predictive analytics.

1.2.6 Use Cases of PAMD Methods and Systems to Enhance DoDIN and DISA Network Defense

Where can PAMD systems enhance DoDIN's network defense capabilities? FIG. 9 shows how the four PAMD systems can help enhance DoDIN's network defense capabilities.

PAMD-A can enhance the sensors capability in the Internet Access Points of DoDIN. PAMD-P, PAMD-M, and PAMD-D can enhance the network defense capability of DoDIN's Cyber Analytic Cloud. PAMD-D can enhance the defense capability of Defensive Cyber Operations Center of DoDIN.

Where can PAMD systems enhance DISA network defense capabilities? FIG. 10 shows how the four PAMD systems can help enhance DISA's network defense capabilities.

PAMD-A can enhance the sensors capability of Internet Access Points for DISA. PAMD-P can enhance the capability of perimeter zero day network defense of Regional Security of DISA. PAMD-M and PAMD-D can enhance the big data capabilities of Operations and Situational Awareness of DISA.

These use cases are examples to show how the PAMD methods and systems can help enhance the cyber defense capabilities for national cybersecurity. These are not the complete set of use cases that PAMD methods and systems can help. The PAMD systems can help in many other ways as the next-gen cyber defense capabilities for enterprise and national security cyber defense.

### BRIEF DESCRIPTION OF THE DRAWINGS

FIG. 1—PAMD Capabilities Framework

FIG. 2—Unique Capability of Predictive Intelligence in the Analytics Maturity-Competition Chart

FIG. 3—A Method to Produce Predictive Intelligence (Chart) from National Security Data Feeds

FIG. 4—Cloud and IoT Cyber Sensors as the PAMD-A Cyber Deception Method

FIG. 5—Cyber Deception as the PAMD-A Method for Next-Gen Network Defense

FIG. 6—PAMD-M Use Case and Live Demo for National Cybersecurity at http://uci.yeswici.com

FIG. 7—Sample PAMD-D Output: Conjoint Analysis for PAMD-A Sensors Data by the RAD Cloud

FIG. 8—PAMD Systems Architecture with Four Interoperable Cloud Systems

FIG. 9—Use Case of PAMD Systems to Enhance DoDIN's Network Defense Capabilities

FIG. 10—Use Case of PAMD Systems to Enhance DISA's Network Defense Capabilities

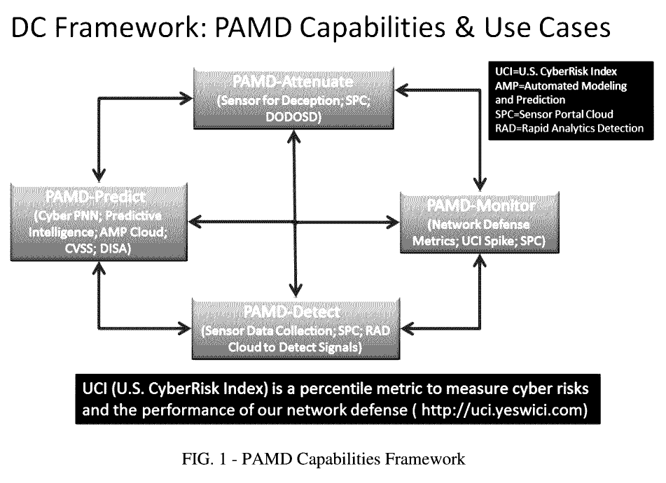

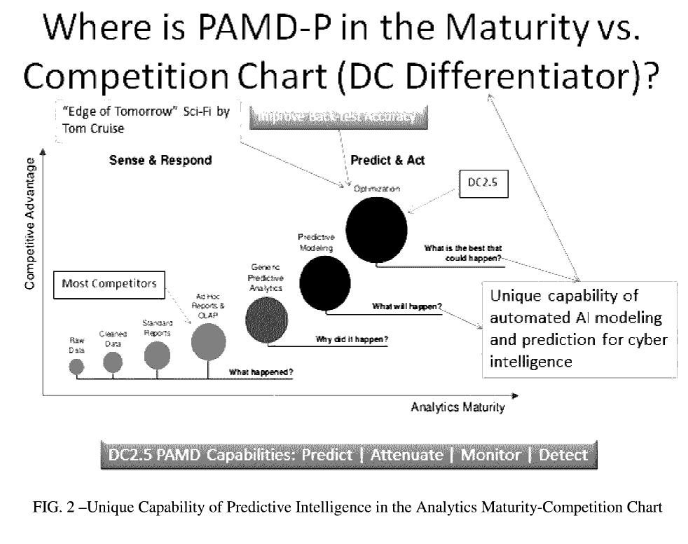

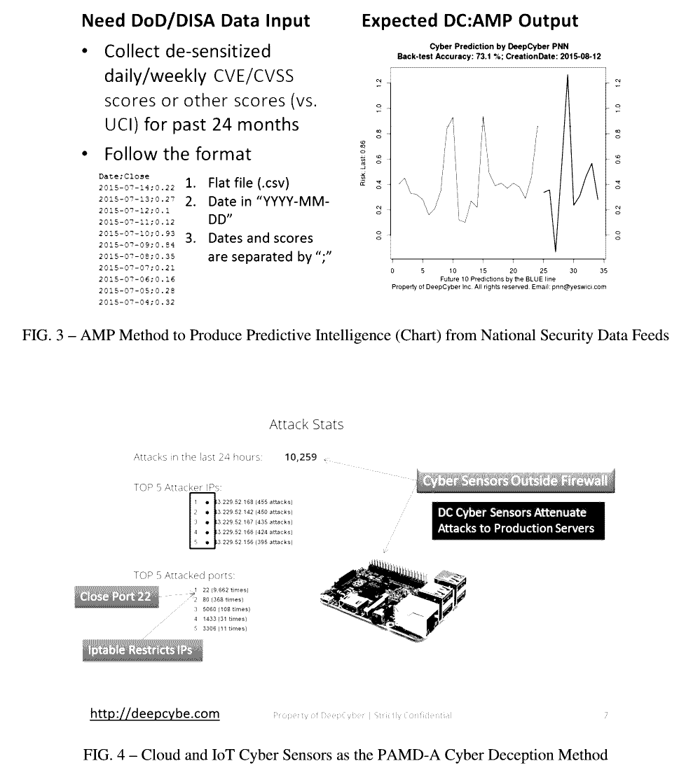

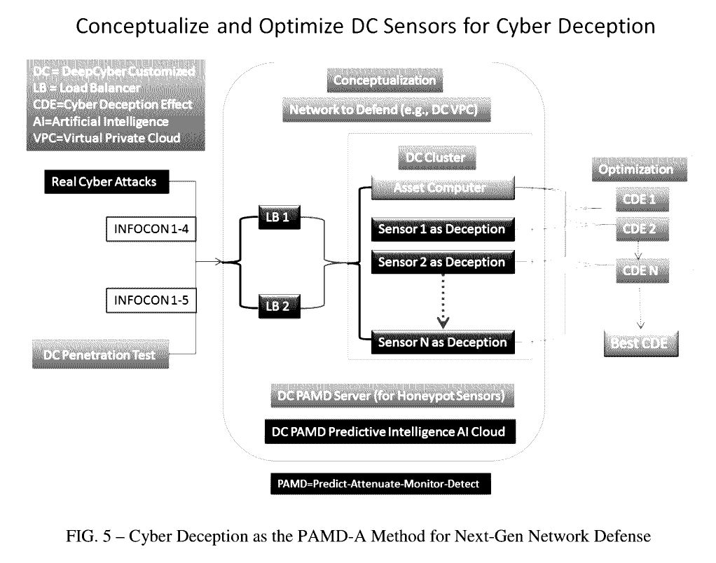

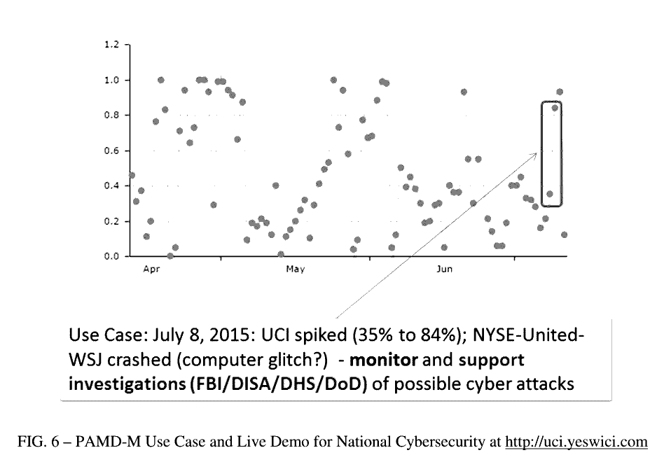

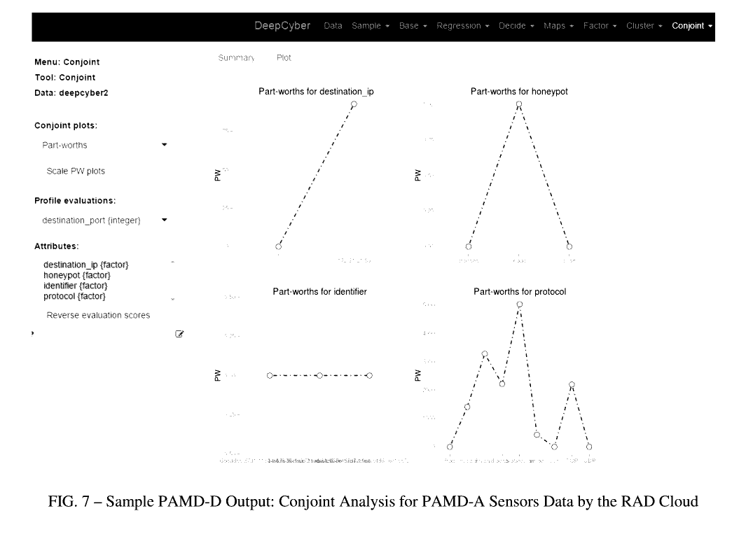

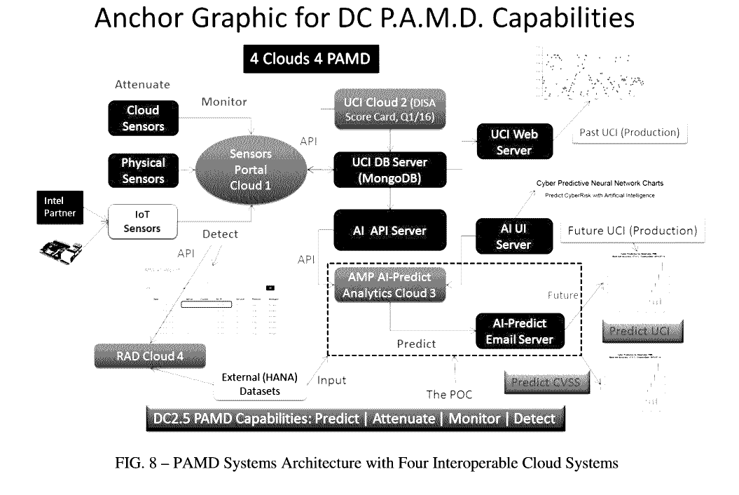

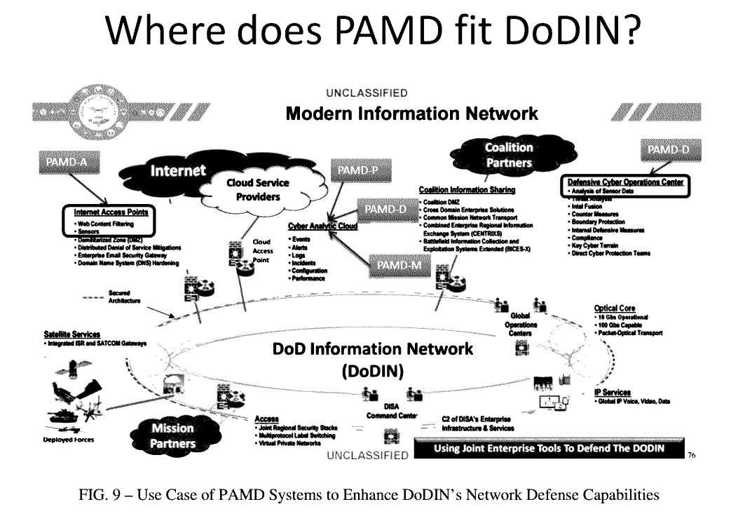

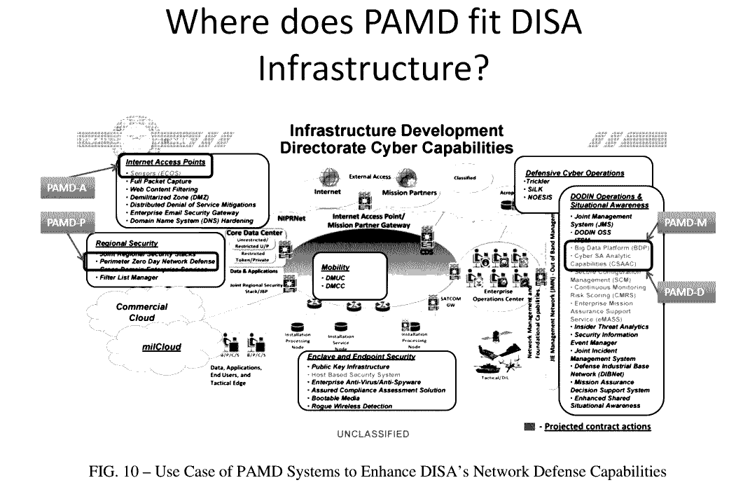

1. What is claimed as my invention is the method and system that enables PAMD-P capability that predicts cyber attacks by the method of automated modeling and computing (AMP) with the deep learning algorithms. The PAMD-P method and capability produces predictive intelligence (may be decisive in winning cyber wars) for enterprise and national cyber defense. It helps better understand the “future” of future-oriented cyber defense by quantifying the time and strength of future cyber attacks. Thus the PAMD-P capability may enable a paradigm shift from past to future-oriented enterprise and national-security cyber defense. This claim also includes the software system called the AMP cloud system that automates the AMP method and artificial neural network algorithms to enable the PAMD-P capability. The AMP cloud system comprises of architecture design artifacts, deep learning algorithms in computer code, back-end computer source code, displays and code for Web user interfaces, workflow process artifacts, capability demonstration artifacts, user manuals (700+ pages), and many other related artifacts. Modeling and predicting future attacks using complex and non-linear data is hard: it normally takes a PhD student 3-5 years to conceptualize, model, and optimize a quantitative model to quantify future events. With the PAMD-P invention in artificial intelligence (neural network) and deep learning algorithms, within weeks the AMP system can automatically model complex new data sets to instantly predict future cyber attacks for national security and enterprise network defense. Both the AMP method and the AMP cloud system are inventions of this claim.

2. What is claimed as my invention is the method and system that enables PAMD-A capability that attenuates and resists cyber attacks by the method of sensor deceptions. The method deploys PAMD-A sensors before and behind firewalls as the perimeter and host cyber defense. The resistance effect is materialized with the PAMD-A sensors as fake targets to mislead cyber attackers as to attenuate the attacking impact to insignificance. The claim also includes a software system called the PAMD-A software sensors and the sensor portal cloud (SPC) system that enables the PAMD-A capability for enterprise and national cyber defense. The software sensors and the SPC system comprise of architecture design artifacts, optimization algorithmic method in computer code to figure out the best attenuation effect, back-end computer source code, displays and code of Web user interfaces, workflow process artifacts, capability demonstration artifacts, user manuals, and many other related artifacts. The PAMD-A method, the sensors and the SPC system are inventions of this claim.

3. What is claimed as my invention are the methods and systems that enable PAMD-M and PAMD-D capabilities that automatically measure the performance of network defense and automatically run a number of analytics on a variety of cyber-related datasets of large volumes. (1) The PAMD-M capability is enabled by the UCI (U.S. CyberRisk Index) method and algorithm that aggregates and transforms dynamic sensors' datasets to a percentile metric to automatically measure the performance of network defense on a regular basis. The automated UCI metric is designed for senior leadership to visualize the current and/or future performance and rigor of network defense. This claim includes a software system called the UCI cloud system that automates the UCI method and enables the PAMD-M capability. (2) The PAMD-D capability automatically detects signals (e.g., by automated data analysis methods for cyber security) from large volumes of structured and unstructured datasets. These signals are actionable latent patterns, anomalies, and insights etc. for leadership (e.g., generals and captains) to make right decisions. This claim also includes a software system called rapid analytics detection (RAD) cloud system that automates the PAMD-D methods (e.g., the conjoint analysis for cyber security) to enable the PAMD-D capability. The RAD cloud is an automated advanced analytics system to detect actionable signals from cyber-related datasets for right decision making. The UCI and RAD systems comprise of architecture design artifacts, algorithmic methods in computer code, back-end computer source code, displays and code of Web user interfaces, workflow process artifacts, capability demonstration artifacts, user manuals, and many other related artifacts. The PAMD-M and PAMD-D methods and UCI and RAD systems are inventions of this claim.
